(19) United States
(12) Patent Application Publication
(10) Pub. No.: US 2025/0307874 A1
(43) Pub. Date: Oct. 2, 2025

(54) STORE SERVER, METHOD, AND STORE SYSTEM

(71) Applicant: Toshiba Tec Kabushiki Kaisha, Tokyo (JP)

(72) Inventor: Takehisa ISHIDA, Sunto Shizuoka (JP)

(21) Appl. No.: 19/026,067

(22) Filed: Jan. 16, 2025

(30) Foreign Application Priority Data
Apr. 1, 2024 (JP) 2024-058997

(51) Int. Cl. G06Q 30/0251; G06Q 30/0601; G06V 20/52

(52) U.S. Cl. CPC G06Q 30/0269; G06Q 30/0255; G06Q 30/0631; G06V 20/52; G06V 2201/07

(57) ABSTRACT

A store server for managing data of items sold in a store, includes a network interface connectable to a customer terminal in the store, a memory, and a processor configured to execute a program stored in the memory. The program causes the server to: upon receipt of an image from the terminal, identify a customer, and acquire customer information corresponding thereto, upon receipt of location information from the terminal, determine a location of the customer in the store, generate first text indicating the location and attributes corresponding to the customer information, input the first text to a machine learning model trained to generate item text indicating an item sold in the store and to be promoted, and generate second text for promoting a first item based on item text output from the model, and control the network interface to transmit the second text to the customer terminal.

### CROSS-REFERENCE TO RELATED APPLICATION(S)

This application is based upon and claims the benefit of priority from Japanese Patent Application No. 2024-058997, filed Apr. 1, 2024, the entire contents of which are incorporated herein by reference.

### FIELD

Embodiments described herein relate generally to a store server, a method, and a store system.

### BACKGROUND

In recent years, a generative AI (Artificial Intelligence) that generates text has attracted attention. The accuracy of the text generated by the generative AI has been improved day by day, and sales promotions using AI-generated text are becoming popular. For example, in response to a query from a customer via a portable terminal such as a smartphone or a tablet terminal, an item that is relevant to the query is offered.

However, the promotion service using the generative AI as described above is generally provided on a cloud computing system. For this reason, there is a possibility that such a promotion service cannot be provided when customers' personal information cannot be stored on the cloud system.

Further, the generative AI used for the promotion service on the cloud is not optimized for sales at individual stores. For this reason, there is a possibility that an item that is not sold at a store may be offered, or a different item of the same type that the store wants to promote may be offered.

### SUMMARY OF THE INVENTION

Embodiments of the present disclosure provide a store server, a method, and a store system.

A store server for managing data of items sold in a store, comprises a network interface connectable to a customer terminal in the store; a memory; and a processor configured to execute a program stored in the memory, the program causing the store server to: upon receipt of an image from the customer terminal, identify a customer based on the received image, and acquire customer information corresponding to the customer, upon receipt of location information from the customer terminal, determine a location of the customer in the store based on the location information, generate first text indicating the location of the customer and one or more attributes corresponding to the customer information, input the first text to a machine learning model that has been trained to generate item text indicating one of items sold in the store and to be promoted for a customer of a particular attribute at a particular location in the store, and generate second text for promoting a first item based on item text that is output from the machine learning model, and control the network interface to transmit the second text to the customer terminal.

### BRIEF DESCRIPTION OF THE DRAWINGS

FIG. 1 is a system diagram illustrating an information processing system according to an embodiment.

FIG. 2 is a block diagram illustrating a hardware configuration of a mobile terminal according to an embodiment.

FIG. 3 is a block diagram illustrating a hardware configuration of a store computer (SC) according to an embodiment.

FIG. 4 is a diagram illustrating a structure of a promotional text database (DB) according to an embodiment.

FIG. 5 is a functional block diagram of the store computer according to an embodiment.

FIG. 6 is a flowchart illustrating a process executed by the store computer according to an embodiment.

### DETAILED DESCRIPTION

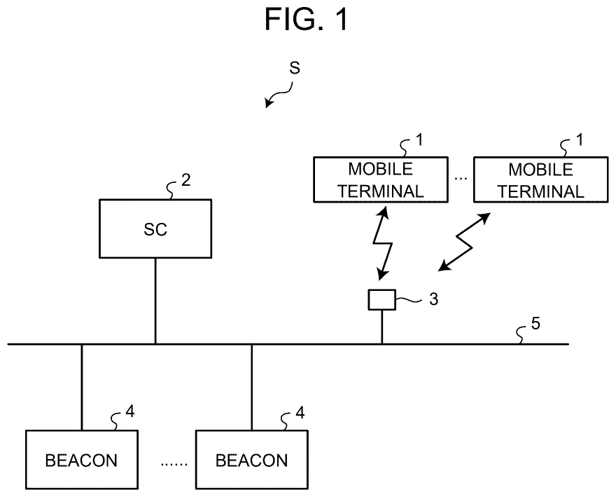

Hereinafter, an information processing apparatus, an information processing system, and a terminal device according to an embodiment will be described in detail with reference to FIGS. 1 to 6. In the embodiments described below, a store computer (SC) installed in a store such as a department store or a supermarket (an example of a facility) is described as an example of an information processing device, but the present disclosure is not limited by the embodiments.

FIG. 1 is a system diagram illustrating an information processing system S according to an embodiment. In FIG. 1, the information processing system S comprises a plurality of mobile terminals 1, an SC 2, an access point 3, and a plurality of beacons 4.

The plurality of mobile terminals 1 are connected to the SC 2 via the access point 3, which is a relay device for wireless communication of wireless communication, and a communication line 5 such as a LAN (Local Area Network), for example. The SC 2, the access point 3, and the beacon 4 are connected to each other via the communication line 5.

Note that the number of apparatuses illustrated in FIG. 1 is an example, and the number of apparatuses included in the information processing system S is not limited to the number illustrated in FIG. 1. For example, the information processing system S may include a plurality of access points 3.

The mobile terminal 1 is a device carried by customers and exchanges various types of data with the SC 2. The mobile terminal 1 is, for example, a smartphone, a tablet terminal, or the like. For example, the mobile terminal 1 transmits a promotion request requesting the SC 2 to generate promotional text.

Further, for example, the mobile terminal 1 receives radio waves from a plurality of beacons 4 (for example, transmitters of radio waves such as Bluetooth (registered trademark) and Wi-Fi) installed in a store. The mobile terminal 1 acquires location information indicating the location of the customer in the store from the reception result of the radio wave.

The SC 2 generates promotional text for customers. For example, the SC 2 is a server device. Note that the SC 2 may perform a process such as a process of collecting and managing item sales registration data received from a point-of-sale (POS) terminal (not shown). The SC 2 may be constituted by one server device or by a plurality of server devices.

For example, the SC 2 transmits the generated promotional text to the mobile terminal 1. Further, for example, the SC 2 receives a promotion request from the mobile terminal 1.

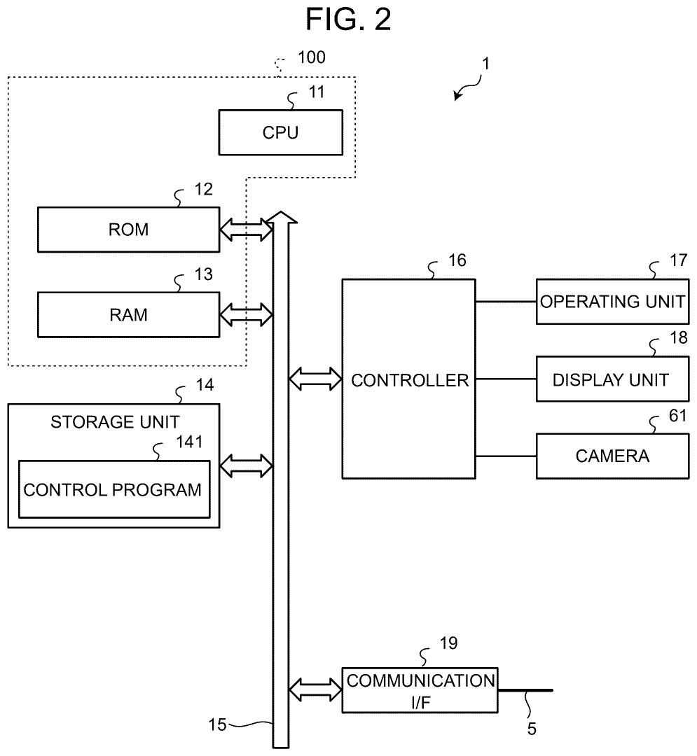

Next, the hardware configuration of the SC 2 will be described. FIG. 2 is a diagram illustrating an exemplary hardware configuration of the SC 2.

As shown in FIG. 2, the SC 2 includes a CPU (Central Processing Unit) 11, a ROM (Read Only Memory) 12 for storing various programs, a RAM (Random Access Memory) 13 for expanding various data, a storage unit 14 for storing various programs, and the like.

The CPU 11, the ROM 12, the RAM 13, the storage unit 14 are connected to each other via a data bus 15. The CPU 11, the ROM 12, and the RAM 13 constitute a control unit 100. That is, the control unit 100 or the CPU 11 executes various processes in accordance with a control program 141 stored in the ROM 12 or the storage unit 14 and loaded into the RAM 13. Those processes will be described later.

The RAM 13 stores various programs including the control program 141, and temporarily stores images captured by a camera 61 until the images are stored in the storage unit 14.

The storage unit 14 is a non-volatile storage device such as an HDD (Hard Disc Drive) or a flash memory that retains stored data even when the power is turned off, and stores programs or the like including the control program 141.

An operation unit 17, a display unit 18, and the camera 61 are connected to the data bus 15 via a controller 16.

The operation unit 17 receives various inputs from customers. For example, the operation unit 17 includes a touch panel.

The display unit 18 is a display that displays various types of information. For example, the display unit 18 displays the promotional text received from the SC 2 in the form of a pop-up or the like.

The camera 61 is a device that captures a face image of a customer. The camera 61 includes solid-state imaging elements of CCD (Charge Coupled Device) and CMOS (Complementary MOS). For example, the camera 61 is provided on a surface of the portable terminal 1 on which the display unit 18 is provided.

For example, when the user or customer of the portable terminal 1 activates an application for receiving an item promotion service on the mobile terminal 1, the camera 61 captures an image of a face of the customer who is looking at the display unit 18 of the mobile terminal 1 in the background.

The data bus 15 is connected to a communication interface (I/F) 19 such as a network interface controller (NIC). The communication I/F 19 is connected to the communication line 5.

The communication I/F 19 transmits and receives various types of data to and from other apparatuses.

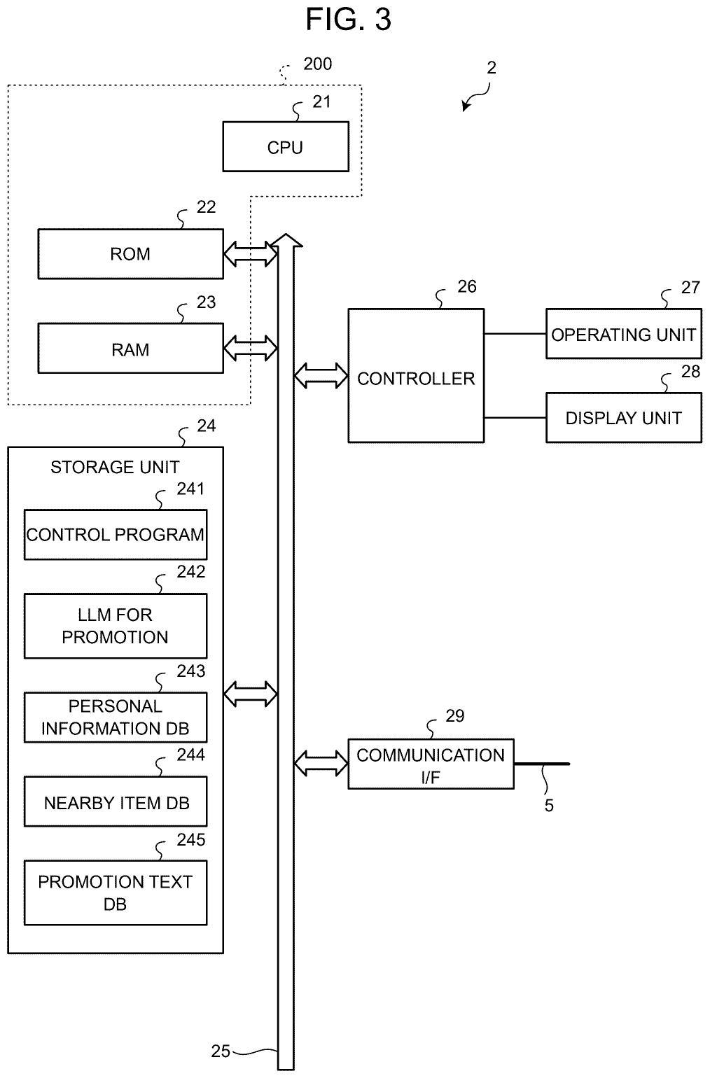

Next, the hardware configuration of the SC 2 will be described. FIG. 3 is a diagram illustrating an exemplary hardware configuration of the SC 2.

As illustrated in FIG. 3, the SC 2 includes a CPU 21, a ROM 22 for storing various programs, a RAM 23 for expanding various types of data, a storage unit 14 for storing various types of programs, and the like.

The CPU 21, the ROM 22, the RAM 23, the storage unit 14 are connected to each other via a data bus 25. The CPU 21, the ROM 22, and the RAM 23 constitute a control unit 200. That is, the control unit 200 or the CPU 21 executes various processes in accordance with a control program 241 stored in the ROM 22 or the storage unit 14 and loaded into the RAM 23. Those processes will be described later.

The RAM 23 stores various programs including the control program 241.

The storage unit 14 is a non-volatile memory storage device such as an HDD or a flash memory that retains stored data even when the power is turned off, and stores programs or the like including the control program 241. The storage unit 14 includes a computer model such as a large language model (LLM) for sales promotion 242, a personal data DB 243, a nearby item DB 244, and a promotional text DB 245.

The LLM for promotion 242 is a generative AI model that generates text. The LLM for sales promotion 242 has been trained to generate item text for promoting items for customers upon input of attributes of a customer, a customer location in the store, etc., which will be described later. Here, the generative AI is used as the LLM, but it is not limited to the LLM as long as it can generate text.

For example, the item text is text data describing a name of an item to be handled at a store and a content to promote the item. Note that the item text may be text data in a list format including names of a plurality of commodities and contents of promoting each of the plurality of commodities.

For example, the LLM for sales promotion 242 is a LLM for outputting text related to an item in response to an input of text specifying a condition, which is constructed by a known deep learning technique. Here, for example, the condition is a constraint condition for narrowing down a reference condition or an output result, which is a reference condition for deriving an output result.

The LLM for sales promotion 242 generates item text corresponding to a customer in response to query text to which customer information related to the customer, such as the customer's location information and the attribute information indicating the attribute of the customer, is added as a condition. The location information and the customer information of the customer will be described later.

The personal information DB 243 manages personal information of customers. For example, the personal information is information of a customer such as an address, a name, an age, a sex, a body size (e.g., height, weight, etc.), a customer ID, a telephone number, an e-mail address, a facial image, identification information of a registered portable terminal such as a terminal ID, and an item purchasing history in a store.

For example, the personal information DB 243 is a database in which, for each customer, the address, name, age, sex, body size, customer ID, telephone number, e-mail address, facial images, identification information of the registered portable terminal, and item purchase history in the store are stored in association with each other.

The nearby item DB 244 is a database that defines, for each location in the store, commodities displayed in the vicinity of the location. For example, the nearby item DB 244 is a database in which information indicating an area in the store and item information are stored in association with each location information in the store. For example, information representing an area in a store is information representing which area of an attribute in the store belongs to, for example, location information within the store such as a men's clothes store, a women's clothes store, or a child's clothing store.

Note that a plurality of pieces of item information may be associated with one piece of location information. In addition, the same item information may be associated with different pieces of location information.

The promotional text DB 245 is a database that stores promotional text for promoting an item.

For example, the promotional text DB 245 stores the promotional text and the semantic vector of the promotional text in association with each other. The promotional text DB 245 is used in a process of generating a promotional text (hereinafter, also referred to as an output promotional text) to be output to the mobile terminal 1. The process of generating the output promotional text using the promotional text DB 245 will be described later.

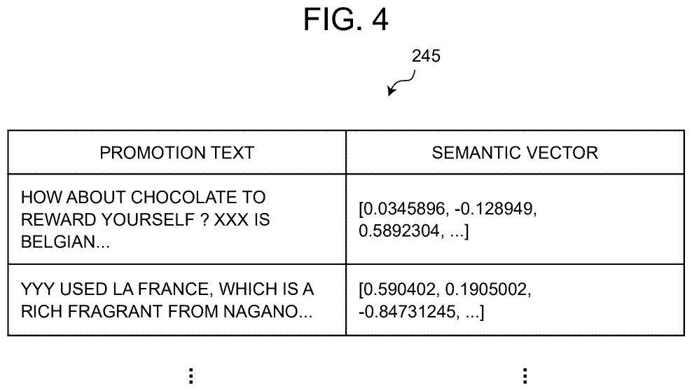

FIG. 4 is a diagram illustrating an exemplary data structure of a promotional text DB 245. As illustrated in FIG. 4, the promotional text DB 245 stores promotional text and a semantic vector in association with each other. For example, promotional text is prepared for all the items sold in the store in advance.

In the first line of FIG. 4, the promotional text “How about chocolate to reward yourself? xxx is Belgian . . . ” is associated with “[0.0345896, −0.128949, 0.5892304, . . . ]”, which represents a semantic vector.

Here, the “xxx” in the promotional text field is text indicating the name of the item. That is, the promotional text in the first record of FIG. 4 is promotional text for promoting the item “xxx”, and the semantic vector thereof is “[0.0345896, −0.128949, 0.5892304, . . . ]”.

In addition, in the second record of FIG. 4, the promotional text, “yyy used La France, which is a rich fragrant from Nagano . . . ”, is associated with “[0.590402, 0.1905002, −0.84731245, . . . ]”, which represents a semantic vector.

Here, the “yyy” in the promotional text field is text indicating the name of the item. That is, the promotional text in the second record of FIG. 4 is promotional text for promoting the item “yyy”, and the semantic vector thereof is “[0.0345896, −0.128949, 0.5892304, . . . ]”.

Returning to FIG. 3, the description will be continued. An operation unit 27 and a display unit 28 are connected to the data bus 25 via a controller 26.

The operation unit 27 receives various inputs from an operator such as a store clerk. For example, the operation unit 27 includes a numeric keypad, various function keys, and the like for inputting numbers.

The display unit 28 displays various types of information.

The data bus 25 is connected to a communication I/F 29 such as a LAN I/F. The communication I/F 29 is connected to the communication line 5.

The communication I/F 29 transmits and receives various types of data.

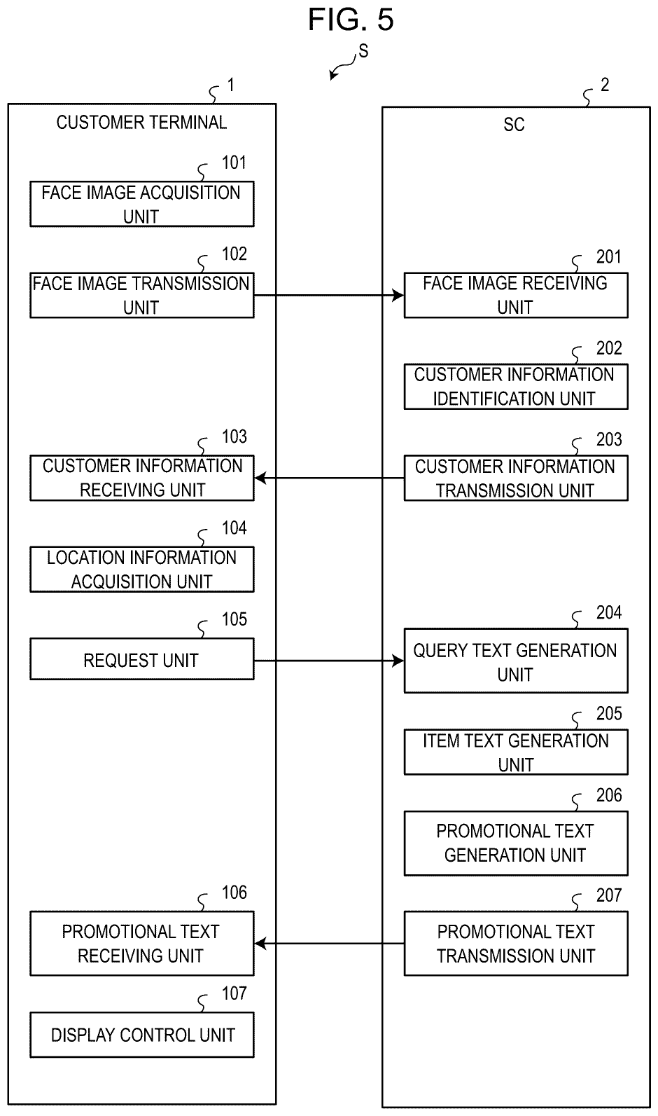

Next, a functional configuration of the information processing system S will be described. FIG. 5 is a functional block diagram illustrating an example of a functional configuration of the information processing system S.

First, a functional configuration of the mobile terminal 1 will be described. The control unit 100 of the mobile terminal 1 functions as a face image acquisition unit 101, a face image transmission unit 102, a customer information receiving unit 103, a location information acquisition unit 104, a request unit 105, a promotional text reception unit 106, and a display control unit 107 by executing various programs including the control program 141 stored in the ROM 12 or the storage unit 14.

The face image acquisition unit 101 acquires image data including a face image of a customer. The image data including the face image of the customer is used to identify customer information regarding the customer who is provided with the promotional service of an item.

For example, the face image acquisition unit 101 controls the camera 61 to capture an image when the customer activates an application. The face image acquisition unit 101 controls the camera 61 to capture an image of the face of the customer who operates the application or the like while viewing the display unit 18 of the mobile terminal 1 in the background.

In addition, the face image acquisition unit 101 analyzes the captured image using a known image recognition technique or the like, and stops the activation of the camera 61 when it is determined that an image including the entire face of the person has been captured. Accordingly, it is possible to suppress consumption of the battery of the mobile terminal 1.

Note that the face image acquisition unit 101 may cause the customer himself/herself to capture his or her face image with the camera 61 by causing the display unit 18 to display a message prompting the customer to capture the face image.

The face image transmission unit 102 transmits image data including the face image of the client to the SC 2. For example, the face image transmission unit 102 transmits image data including the face image of the customer acquired by the face image acquisition unit 101 to the SC 2 via the communication I/F 19, the access point 3, and the communication line 5.

The customer information receiving unit 103 receives customer information from the SC 2. For example, the customer information receiving unit 103 receives, from the SC 2, the customer information of the customer specified based on the image data including the face images of the customer and the personal information DB 243 via the communication I/F 19, the access point 3, and the communication line 5.

The location information acquisition unit 104 acquires location information of the customer representing the location of the customer in the store. For example, the location information acquisition unit 104 acquires location information of the customer in real time based on a reception result of the radio wave transmitted from the beacon 4.

Specifically, the location information acquisition unit 104 specifies the location of the own device (i.e., the portable terminal 1) in the store from the information indicating the received power of the radio wave from which beacon 4 in the store included in the reception result of the radio wave transmitted from the beacon 4. Then, the location information acquisition unit 104 acquires, as the location information of the customer, the information indicating the specified location of the own device.

Note that the process of acquiring the location information of the customers may be performed by the SC 2. In this case, the mobile terminal 1 transmits the reception result of the radio wave transmitted from the beacon 4 and the device ID identifying the own device to the SC 2 in association with each other.

In the same process as described above, the SC 2 specifies the location of the mobile terminal 1 identified by the device ID associated with the reception result of the radio wave transmitted from the mobile terminal 1, and acquires the information indicating the identified location of the mobile terminal 1 as the location information of the client using the mobile terminal 1.

The request unit 105 transmits a promotion request requesting generation of promotional text to the SC 2. For example, the request unit 105 transmits a promotion request including the customer information of the customer received by the customer information receiving unit 103 and the location information of the customer specified by the location information acquisition unit 104 to the SC 2.

Further, the request unit 105 determines whether the customer has moved to a different area in the store based on the location information of the customer.

For example, the request unit 105 refers to the nearby item DB 244 and specifies an area in the store corresponding to the location information of the customer acquired by the location information acquisition unit 104. The request unit 105 compares the specified area in the store with the area corresponding to the location information of the customer acquired last time, and determines that the customer has moved to a different area in the store when the two areas are different.

The request unit 105 transmits the above-described promotion request to the SC 2 when it is determined that the customer has moved to a different area in the store.

The promotional text receiving unit 106 receives promotional text from the SC 2. For example, the promotional text receiving unit 106 receives the promotional text transmitted from the SC 2 in response to the promotion request.

The display control unit 107 performs control to display various kinds of information on the display unit 18. For example, the display control unit 107 performs control to cause the display unit 18 to pop-up display the promotional text received from the SC 2.

Next, the functional configuration of the SC 2 will be described. The control unit 200 of the SC 2 functions as a face image receiving unit 201, a customer information identification unit 202, a customer information transmission unit 203, a query text generation unit 204, an item text generation unit 205, a promotional text generation unit 206, and a promotional text transmission unit 207 by executing various programs including the control program 241 stored in the ROM 22 or the storage unit 24.

The face image receiving unit 201 receives image data including a face image of a customer. For example, the face image receiving unit 201 receives the image data including the face image of the customer transmitted from the mobile terminal 1 via the communication line 5.

The customer information identification unit 202 specifies customer information of the customer. For example, the customer information is information related to a customer, such as attribute information related to the attributes of the customer, an item purchase history in the store, and the like. Further, for example, the attribute information is information indicating the attributes of the customer such as an address, age, sex, and physique of the customer.

For example, the customer information identification unit 202 extracts the face image of the customer from the image data including the face image of the customer received from the mobile terminal 1 using a known image recognition technique. The customer information identification unit 202 refers to the personal information DB 243 stored in the storage unit 24, and specifies an address, a name, an age, a sex, a physique, a customer ID, a telephone number, an email address, and an item purchase history in the store corresponding to the extracted face image as customer information of the customer corresponding to the face image.

The customer information transmission unit 203 transmits the customer information of the customer to the portable terminal 1. For example, the customer information transmission unit 203 transmits the customer information of the customer specified by the customer information transmission unit 203 to the portable terminal 1 via the communication line 5.

The query text generation unit 204 generates a query text based on the promotion request. The query text is instruction information (for example, prompt) indicating the content of the text to be generated in the generative AI. Hereinafter, the content instructed by the instruction information is also referred to as instruction content.

For example, the query text generation unit 204 instructs the LLM for sales promotion 242 to generate text including the name of an item and the content for promoting the item, and generates query text describing the content for instructing that the item to be promoted is an item sold at the store and that the item to be promoted is derived from the customer information of the customer and the condition based on the location information of the customer.

Here, a template for generating the query text is stored in advance in the storage unit 24 or the like. Note that a plurality of templates may be stored in the storage unit 24 or the like. In this case, the query text generation unit 204 may selectively use a plurality of templates according to the situation. For example, the query text generation unit 204 may switch the templates according to a keyword included in the query text (for example, a word capable of discriminating a genre of an item (food, clothing, or the like)).

Further, the query text generation unit 204 adds, to the query text, text data based on customer information of the customer and location information of the customer included in the promotion request received from the mobile terminal 1, in accordance with the condition specified by the instruction content.

Specifically, the query text generation unit 204 adds, to the query text, text data including a description regarding the location information of the customer, the item information of the item existing in the vicinity of the customer, a description regarding the attribute information of the customer, and a description regarding the item purchase history of the customer, as conditions.

For example, the query text generation unit 204 adds, to the query text, as a condition, text data that is described as “near the underwear counter” or the like as a description regarding the location information of the customer, based on the location information of the customer included in the promotion request.

In addition, the query text generation unit 204 refers to the neighborhood item DB 145 and specifies the item information corresponding to the location information of the customer included in the promotion request. The query text generation unit 204 adds text data describing the name of the item included in the specified item information as item information of the item existing in the vicinity of the customer to the query text as a condition.

Further, the query text generation unit 204 adds, as a condition, text data described as “30 years old, female, slender” or the like to the query text as a description regarding the attribute information of the customer, based on the customer information of the customer included in the promotion request.

Further, the query text generation unit 204 adds, to the query text, the text data describing “purchase of a shirt having item code XX on DAY/MONTH” or the like as a description regarding the item purchase history of the customer, based on the customer information of the customer included in the promotion request.

By including a description of the purchase history of the item of the customer as a condition in the query text and adding an instruction to the content of the instruction to the effect that the purchased item is not output, it is possible to prevent the customer from recommending the customer to purchase the already purchased item.

In addition, by adding an instruction to the query text to preferentially promote an item similar to the purchased item (an item of the same brand, an item of a similar color, an item having a similar shape, or the like), which is an item that has not been purchased, and the like, it is possible to promote an item that is considered to be closer to the preference of the customer.

The item text generation unit 205 generates item text based on the query text. For example, the item text generation unit 205 inputs the query text generated by the query text generation unit 204 into the LLM for sales promotion 242 stored in the storage unit 24. The item text generation unit 205 acquires the text data output from the LLM for sales promotion 242 as the item text.

Note that a part or all of the processing of the query text generation unit 204 described above may be executed by the item text generation unit 205. In addition, the query text generation unit 204 may execute some or all of the processing of the item text generation unit 205.

Incidentally, as described above, the item text is text data generated by using the LLM for sales promotion 242 that is a generative AI. Therefore, the LLM for sales promotion 242 generates different texts as item texts each time. That is, even if text promoting the same item is generated, the contents thereof are different each time.

Therefore, there is a possibility that text including a difficult-to-understand expression is generated, or text including an inappropriate expression is generated when a promotion is performed in a store. Therefore, the promotional text generation unit 206, which will be described later, performs a process of generating an output promotional text based on the item text so that the item can be promoted unified by an appropriate expression.

Hereinafter, the promotional text generation unit 206 will be described. The promotional text generation unit 206 generates output promotional text based on item text. The output promotional text is text data obtained by converting the item text into a representation suitable for promoting the item text in the store.

For example, the promotional text generation unit 206 calculates a semantic vector of the item text generated by the item text generation unit 205 using a known natural language processing technique or the like. Next, the promotional text generation unit 206 refers to the promotional text DB 245 and specifies the promotional text corresponding to the semantic vector most approximate to the calculated semantic vector of the item text.

The promotional text generation unit 206 generates the specified promotional text as output promotional text.

The promotional text transmission unit 207 transmits the promotional text to the mobile terminal 1. For example, the promotional text transmission unit 207 transmits the output promotional text generated by the promotional text generation unit 206 to the mobile terminal 1.

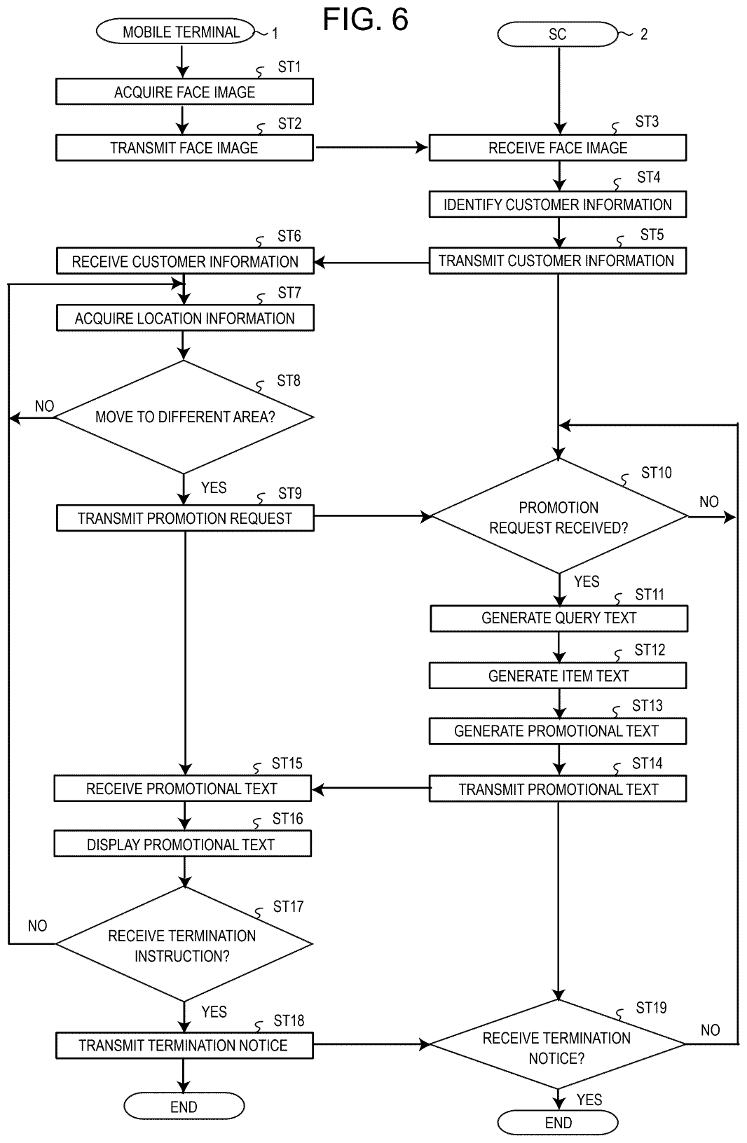

Next, the processing executed by the information processing system S will be described with reference to FIG. 6. FIG. 6 is a flowchart illustrating an example of processing executed by the information processing system S.

First, the face image acquisition unit 101 of the control unit 100 of the mobile terminal 1 acquires a face image of a customer (step ST1). For example, when the customer activates the application, the face image acquisition unit 101 controls the camera 61 to capture a face image of the customer, thereby acquiring image data including the face image of the customer.

Next, the face image transmission unit 102 transmits the face image to the SC 2 (step ST2). For example, the face image transmission unit 102 transmits, to the SC 2, image data including the face image of the customer acquired in the step ST1 via the access point 3 and the communication line 5.

Next, the face image receiving unit 201 of the control unit 200 of the SC 2 receives the face image of the customer (step ST3). For example, the face image receiving unit 201 receives, via the communication line 5, image data including the face image of the customer transmitted from the mobile terminal 1 in the step ST2.

Next, the customer information identification unit 202 identifies the customer information of the customer based on the face images of the customer (step ST4). For example, the customer information identification unit 202 extracts the face image of the customer from the image data of the face image of the customer received in the step ST3. The customer information identification unit 202 refers to the personal information DB 243 and specifies a plurality of pieces of information associated with the extracted face images of the customer as customer information of the customer.

Next, the customer information transmission unit 203 transmits the customer information of the customer (step ST5). For example, the customer information transmission unit 203 transmits the customer information of the customer specified in the step ST4 to the portable terminal 1 via the communication line 5. After the step ST5, the process by the control unit 200 of the SC 2 proceeds to step ST10, which will be described later.

On the other hand, after the step ST5, in the control unit 100 of the mobile terminal 1, the customer information receiving unit 103 receives the customer information (step ST6). For example, the customer information receiving unit 103 receives the customer information of the customer transmitted from the SC 2 in the step ST5.

Next, the location information acquisition unit 104 acquires the location information of the customers (step ST7). For example, the location information acquisition unit 104 specifies the location of the own device in the store on the basis of the reception result of the radio wave transmitted by the beacons 4 installed at a plurality of locations in the store. The location information acquisition unit 104 acquires, as the location information of the customer, information indicating the location of the specified own device in the store.

Note that, in FIG. 6, the process of acquiring the location information of the customer is described as step ST7, but the process of acquiring the location information of the customer is assumed to be continuously performed.

Next, the request unit 105 determines whether the customer has moved to a different area based on the location of the customer (step ST8). For example, the request unit 105 refers to the nearby item DB 244 and identifies an area in the store corresponding to the location information acquired by the location information acquisition unit 104 to determine whether the customer has moved to a different area.

Specifically, the request unit 105 compares the specified area in the store with the area corresponding to the location information of the customer acquired last time, and determines that the customer has moved to a different area in the store when the two areas are different. On the other hand, the area in the specified store is compared with the area corresponding to the location information of the customer acquired last time, and if both are the same, it is determined that the customer is not moving to a different area in the store.

When the acquisition of the location information of the customer by the location information acquisition unit 104 in the step ST7 is the acquisition of the first-time location information, the request unit 105 determines that the customer has moved to a different area and performs the above-described determination.

If the customer has not moved to a different area (step ST8: No), the process of the control unit of the mobile terminal 1 returns to the process of step ST7. On the other hand, if the customer has moved to a different area (step ST8: Yes), the request unit 105 transmits a promotion request (step ST9).

For example, the request unit 105 transmits a promotion request including the customer information of the customer received in the step ST6 and the latest location information of the customer acquired in the step ST7 to the SC 2. After the step ST9, the process by the control unit 100 of the mobile terminal 1 proceeds to step ST15 described later.

On the other hand, after the above-described step ST5, the control unit 200 determines whether the query text generation unit 204 has received the promotion request from the mobile terminal 1 (step ST10). If no promotion request has been received (step ST10: No), the process of step ST10 is repeated.

On the other hand, when the promotion request is received (step ST10: Yes), the query text generation unit 204 generates query text (step ST11). For example, the query text generation unit 204 generates the query text based on the customer information of the customer and the location information of the customer included in the promotion request received in the step ST10.

Specifically, the query text generation unit 204 generates query text instructing generation of text relating to an item handled in a store, which is added on condition of a description relating to attribute information of the customer, a description relating to an item purchase history of the customer, and a description relating to location information of the customer.

Next, the item text generation unit 205 generates item text (step S12). For example, the item text generation unit 205 inputs the query text generated in the step S11 into the LLM for sales promotion 242 stored in the storage unit 14. The item text generation unit 205 acquires the text data output from the LLM for sales promotion 242 as item text.

Next, the promotional text generation unit 206 generates promotional text based on the item text (step ST13).

For example, the promotional text generation unit 206 calculates a semantic vector of the item text generated in the step ST12. Then, the promotional text generation unit 206 refers to the promotional text DB 245 and specifies promotional text having a semantic vector that is most similar to the semantic vector of the calculated item text. The promotional text generation unit 206 generates the specified promotional text as output promotional text.

Next, the promotional text transmission unit 207 transmits the promotional text (step ST14). For example, the promotional text generation unit 206 transmits the output promotional text generated in the step ST13 to the mobile terminal 1. After the step ST14, the process by the control unit 200 of the SC 2 proceeds to step ST19, which will be described later.

On the other hand, after the above-described step ST9, in the control unit 100 of the mobile terminal 1, the promotional text receiving unit 106 receives the output promotional text (step ST15). For example, the promotional text receiving unit 106 receives the output promotional text transmitted from the SC 2 in the step ST14.

Next, the display control unit 107 causes the promotional text to be displayed (step ST16). For example, the display control unit 107 performs control to cause the display unit 18 to pop-up display the output promotional text received in the step ST15.

Next, the location information acquisition unit 104 determines whether an instruction to terminate the promotion service has been received from the client (step ST17). For example, the location information acquisition unit 104 determines that the termination instruction of the promotion service has been received when the termination instruction of the application is received from the customer.

Note that the location information acquisition unit 104 may determine that an instruction to terminate the promotion service has been received when it is detected that the customer has left the store.

When the termination instruction has not been received (step ST17: No), the process by the control unit 100 of the mobile terminal 1 returns to the above-described step ST7. On the other hand, when the termination instruction is received (step ST17: Yes), the control unit 100 of the mobile terminal 1 transmits the termination notification of the promotion service to the SC 2 (step ST18), and ends the present process.

On the other hand, after the above-described step ST14, the control unit 200 determines whether the query text generation unit 204 has received a termination notice of the promotion service from the mobile terminal 1 (step ST19). If the termination notice of the promotion service has not been received (step ST19: No), the process by the control unit 200 of the SC 2 returns to the above-described step ST10.

On the other hand, when the termination notice of the promotion service is received (ST19: No), the control unit 200 of the SC 2 ends this process.

As described above, the information processing system S performs control to acquire customer information related to a customer including a characteristic of the customer, acquire location information indicating a location in the facility of the customer, generate query text based on the customer information and the location information of the customer, input the query text into a generative AI that generates an item text related to an item handled in the facility in response to the input of the query text, generate promotional text based on the item text generated by the generative AI, and display the promotional text on the display unit 18 of the portable terminal 1 used by the customer.

As a result, the information processing system S can generate query text considering information on a customer and a location in a store where the customer is located. By query text considering information about a customer or a location in a store where a customer is located is entered into the LLM for sales promotion 242 as a generative AI to generate item text, it is possible to generate item text optimized for the customer. Further, by generating promotional text obtained by converting the item text into a representation suitable for the promotion of the item, it is possible to promote the item unified with a more appropriate representation. Further, since the information processing system S causes the mobile terminal 1 used by the customer to display the promotional text, the information processing system S can provide a promotion service for an item regardless of where the customer is in the store. In other words, according to the information processing system S, it is possible to improve the convenience of promotion to which the generative AI is applied.

In addition, the information processing system S generates text for query added with a description related to the attribute of the customer as a condition. As a result, the information processing system S can promote the item in consideration of the age, sex, physique, and the like of the customer.

Further, the information processing system S generates text for query added on condition that a description related to an item purchase history of a customer is added. As a result, the information processing system S can prevent a situation in which a previously purchased item is recommended to a customer, and can preferentially promote an item similar to an item that has not been purchased yet.

Further, the information processing system S acquires the location information in the store of the customer, specifies the item information of the item in the vicinity of the location information from the acquired location information, and generates the query text added with the description of the specified item information as a condition. As a result, the information processing system S can recommend the purchase of an item located near the current location of the customer.

Further, the information processing system S specifies promotional text having the most similar semantic vector to the item text among the promotional text stored in the promotional text DB 245 based on the semantic vector of the item text and the promotional text DB 245 in which the promotional text and the semantic vector of the promotional text are stored in association with each other, and generates the promotional text to be output.

Incidentally, the item text generated by the LLM for sales promotion 242 that is the generative AI can be different each time. Therefore, even if the item text is related to the same item, the expression can be different each time. Therefore, there is a possibility that item text including a difficult-to-understand expression is generated, or item text including an expression that is not suitable for promoting at a store is generated. Since the information processing system S generates the output promotional text using the generated item text and the promotional text DB 245 storing the promotional text appropriate for the promotion of the item, the information processing system S can promote the item with a more appropriate expression to the customer.

Further, the information processing system S performs control of causing the display unit 18 of the mobile terminal 1 to display the promotional text as a pop-up message. As a result, it is possible to attract the interest of the customer and to promote the item effectively.

Note that the above-described embodiments can be modified and implemented as appropriate by changing a part of a configuration or a function of each device constituting the information processing system S. Therefore, in the following, some modifications according to the above-described embodiments will be described as other embodiments. Note that, in the following, differences from the above-described embodiments will be mainly described, and detailed descriptions of the same points as those described above will be omitted. Further, the modification examples described below may be implemented individually or in combination as appropriate.

### (Modification 1)

In the above-described embodiments, the SC 2 includes the LLM for sales promotion 242. In the present modification, a configuration in which a server device other than the SC 2 includes the LLM for sales promotion 242 will be described.

In the present modification, a server device including the LLM for sales promotion 242 is provided in a store in the same manner as in the SC 2. Note that the server device may be provided outside the store, but since information including personal information of customers is inputted to the LLM for sales promotion 242, it is preferable to provide the server device in a location where a person independent of the store does not easily access the server device when the server device is provided outside the store.

The item text generation unit 205 according to the present modification transmits the query text generated by the query text generation unit 204 to the server device via the communication line 5. The server device enters the query text received in the LLM for sales promotion 242. The server device transmits the item text output from the LLM for sales promotion 242 to the SC 2.

According to this modification, it is possible to reduce the burden of the SC 2.

### (Modification 2)

In the embodiments and the modification described above, a mode in which promotional text is displayed on the display unit 18 of the mobile terminal 1 has been described. In the present modification, a form in which voice data based on promotional text is output in place of or in addition to the display will be described.

In this modification, the control unit 200 of the SC 2 generates promotion voice text for promoting an item based on the promotional text generated by the promotional text generation unit 206. For example, the control unit 200 of the SC 2 generates promotion voice text using a voice converting LLM.

The voice converting LLM is an AI and LLM for generating texts. The voice converting LLM is stored in the storage unit 14 or the like. The voice converting LLM generates promotion voice text. For example, the promotion voice text is text that recommends a customer to purchase an item in an expression that is considered natural when described verbally.

For example, the voice converting LLM is an LLM for outputting promotion voice text for inputting an item text constructed by a known deep learning technique.

The voice converting LLM 143 according to the present modification generates promotion voice text for the customer in response to inputting text data obtained by adding the customer information of the customer and the content related to the location information of the customer to the item text. The control unit 200 of the SC 2 generates voice data based on the promotion voice text. The control unit 200 of the SC 2 transmits the generated audio data to the mobile terminal 1.

The control unit 100 of the mobile terminal 1 performs control to output audio data received from the SC 2 from an audio output device such as a speaker of the mobile terminal 1.

According to the present modification, it is possible to promote the item to the customer who is shopping by looking away from the display unit 18 of the mobile terminal 1.

The program(s) execution by the portable terminal 1 and the SC 2 of the above-described embodiments and modifications are recorded in a non-transitory computer-readable recording medium such as a CD-ROM, a flexible disk (FD), or a CD-R, a DVD (Digital Versatile Disk) in an installable format or an executable format.

Further, the program(s) executed by the portable terminal 1 and the SC 2 of the above-described embodiments and modifications may be stored in a computer connected to a network such as the Internet, and may be downloaded through the network. Further, the program(s) executed by the portable terminal 1 and the SC 2 of the embodiments and modifications may be provided or distributed over a network such as the Internet.

Further, the program(s) executed by the portable terminal 1 and the SC 2 of the embodiments and modifications may be stored in the ROM 12, the ROM 22, the storage unit 14, the storage unit 24, or the like in advance.

While certain embodiments have been described, these embodiments have been presented by way of example only, and are not intended to limit the scope of the disclosure. Indeed, the novel embodiments described herein may be embodied in a variety of other forms; furthermore, various omissions, substitutions and changes in the form of the embodiments described herein may be made without departing from the spirit of the disclosure. The accompanying claims and their equivalents are intended to cover such forms or modifications as would fall within the scope and spirit of the disclosure.

What is claimed is:

1. A store server for managing data of items sold in a store, comprising:
a network interface connectable to a customer terminal in the store;
a memory; and
a processor configured to execute a program stored in the memory, the program causing the store server to:
upon receipt of an image from the customer terminal, identify a customer based on the received image, and acquire customer information corresponding to the customer,
upon receipt of location information from the customer terminal, determine a location of the customer in the store based on the location information,
generate first text indicating the location of the customer and one or more attributes corresponding to the customer information,
input the first text to a machine learning model that has been trained to generate item text indicating one of the items sold in the store and to be promoted for a customer of a particular attribute at a particular location in the store, and generate second text for promoting a first item based on item text that is generated by and output from the machine learning model, and
control the network interface to transmit the second text to the customer terminal.

2. The store server according to claim 1, wherein
the machine learning model is a generative artificial intelligence (AI) model of a large language model (LLM).

3. The store server according to claim 1, wherein
the machine learning model has been further trained to generate text for promoting an item upon input of item text indicating the item, and
the program causes the store server to input the item text that is output from the machine learning model to the machine learning model to generate the second text.

4. The store server according to claim 1, wherein
the program causes the store server to acquire a purchase history of the identified customer, and determine a purchased item that has been purchased by the customer in the store, and
the first text further indicates the purchased item.

5. The store server according to claim 4, wherein
the machine learning model has been trained to generate item text indicating one of the items sold at the store except for the purchased item.

6. The store server according to claim 1, wherein
the memory stores item data in which each of the items sold in the store is associated with a corresponding one of locations in the store, and
the machine learning model is trained to generate, based on the item data, item text indicating one of the items sold in the store and located at one of the locations in the store.

7. The store server according to claim 1, wherein
the memory stores promotional text data in which each of a plurality of promotional text is associated with a corresponding one of semantic vectors indicating a meaning of the promotional text, and
the program causes the store server to:
calculate a semantic vector of the item text that is output from the machine learning model, and
search for the promotional text data for promotional text corresponding to the calculated semantic vector to generate the second text.

8. The store server according to claim 1, wherein
the program causes the store server to transmit an instruction to the customer terminal, the instruction causing the customer terminal to display the second text.

9. The store server according to claim 1, wherein
the program causes the store server to transmit an instruction to the customer terminal, the instruction causing the customer terminal to output a voice sound corresponding to the second text.

10. The store server according to claim 1, wherein
the network interface is connectable to a point-of-sale (POS) terminal installed in the store, and
the program causes the store server to store information about the items received from the POS terminal.

11. A method performed by a store server for managing data of items sold in a store, the method comprising:
upon receipt of an image from a customer terminal, identifying a customer based on the received image, and acquiring customer information corresponding to the customer;
upon receipt of location information from the customer terminal, determining a location of the customer in the store based on the location information;
generating first text indicating the location of the customer and one or more attributes corresponding to the customer information;
inputting the first text to a machine learning model that has been trained to generate item text indicating one of the items sold in the store and to be promoted for a customer of a particular attribute at a particular location in the store, and generating second text for promoting a first item based on item text that is generated by and output from the machine learning model; and
transmitting the second text to the customer terminal.

12. The method according to claim 11, wherein
the machine learning model is a generative artificial intelligence (AI) model of a large language model (LLM).

13. The method according to claim 11, wherein
the machine learning model has been further trained to generate text for promoting an item upon input of item text indicating the item, and
the method further comprises:
inputting the item text that is output from the machine learning model to the machine learning model to generate the second text.

14. The method according to claim 11, further comprising:
acquiring a purchase history of the identified customer, and determining a purchased item that has been purchased by the customer in the store, wherein
the first text further indicates the purchased item.

15. The method according to claim 14, wherein
the machine learning model has been trained to generate item text indicating one of the items sold at the store except for the purchased item.

16. The method according to claim 11, wherein
the method further comprises:
storing, in a memory, item data in which each of the items sold in the store is associated with a corresponding one of locations in the store, and
the machine learning model is trained to generate, based on the item data, item text indicating one of the items sold in the store and located at one of the locations in the store.

17. The method according to claim 11, further comprises:
storing, in a memory, promotional text data in which each of a plurality of promotional text is associated with a corresponding one of semantic vectors indicating a meaning of the promotional text;
calculating a semantic vector of the item text that is output from the machine learning model; and
searching for the promotional text data for promotional text corresponding to the calculated semantic vector to generate the second text.

18. The method according to claim 11, further comprising:
transmitting an instruction to the customer terminal, the instruction causing the customer terminal to display the second text.

19. The method according to claim 11, further comprising:
transmitting an instruction to the customer terminal, the instruction causing the customer terminal to output a voice sound corresponding to the second text.

20. A store system comprising:
a plurality of beacon devices installed in a store;
a customer terminal configured to:
capture an image of a customer and output the image, and
receive signals from the beacon devices and generate location information indicating a location of the customer terminal in the store based on the signals; and
a store server including a memory and configured to:
upon receipt of the image that is output from the customer terminal, identify the customer based on the received image, and acquire customer information corresponding to the customer,
upon receipt of the location information from the customer terminal, determine the location of the customer in the store based on the location information,
generate first text indicating the location of the customer and one or more attributes corresponding to the customer information,
input the first text to a machine learning model that has been trained to generate item text indicating one of items sold in the store and to be promoted for a customer of a particular attribute at a particular location in the store, and generate second text for promoting a first item based on item text that is output from the machine learning model, and
transmit the second text to the customer terminal, wherein
the customer terminal is further configured to display the second text that is transmitted from the store server.
